(19) United States
(12) Patent Application Publication
(10) Pub. No.: US 2024/0319684 A1
(43) Pub. Date: Sep. 26, 2024

(54) METHOD FOR DIMENSIONING A RECEIVING DEVICE

(71) Applicant: Siemens Aktiengesellschaft, 80333 München (DE)

(72) Inventors: Johannes Fürst, Schönberg (DE); TOBIAS JÄGER, Baiersdorf Igelsdorf (DE); STEFAN RUNDE, Leipzig (DE)

(73) Assignee: Siemens Aktiengesellschaft, 80333 München (DE)

(21) Appl. No.: 18/579,144

(22) PCT Filed: Jun. 15, 2022
(86) PCT No.: PCT/EP2022/066291

§ 371 Date: Jan. 12, 2024

(30) Foreign Application Priority Data
Jul. 15, 2021 (EP) 21185888.1

(51) Int. Cl. G05B 13/04

(52) U.S. Cl. CPC G05B 13/04

(57) ABSTRACT

In a method for dimensioning a receiving device for use in an industrial process, control of the industrial process is simulated by a virtual controller. A dynamic control variable based on the simulation of the virtual controller is outputted and a dynamic process variable is determined based on the dynamic control variables. The receiving device is dimensioned by taking into account the determined dynamic process variable.

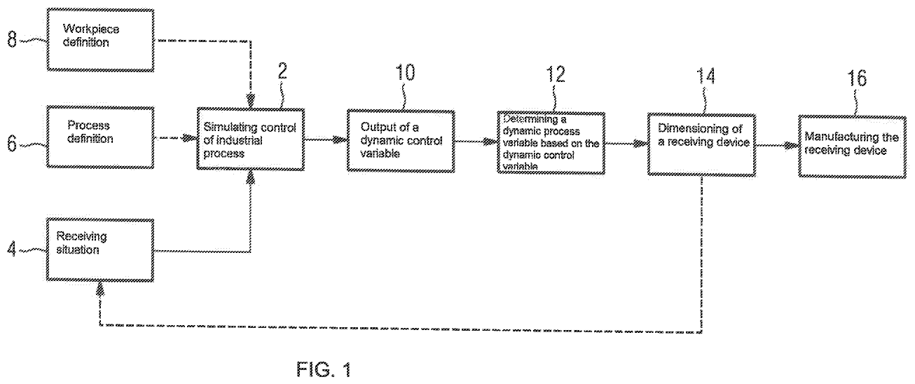

The invention relates to a method for dimensioning a receiving device.

The invention further relates to a method for manufacturing a receiving device, which is dimensioned according to a method of this type.

Moreover, the invention relates to a control unit comprising at least one processor.

Furthermore, the invention relates to a computer program comprising program code, which can be executed by at least one processor and which causes the at least one processor to perform a method of this type.

During the manufacture of components on a machine tool, these are fixed in a working space. A machine tool of this type is realized as a milling machine or turning machine, for instance. The mechanical fixing takes place by means of a receiving device, which is realized as a clamping device, for instance. A receiving device of this type is thus designed so that the component to be received is held securely at the defined position with the developing process forces, which is why the receiving device has to be sufficiently resilient, in particular mechanically, must not deform as a result of tolerances and is rigid against the dynamic forces of the manufacturing process. Dynamic influences are inter alia relative movements of a clamping table with respect to a tool, and vice versa.

Further demands on a receiving device of this type are that this is simultaneously favorable in respect of the manufacture and material and is light for effective handling and machine dynamics. To achieve an optimal design of the . . . receiving device, the kinematic and dynamic properties of the machine tool are to be taken into account. The dynamic properties can inter alia comprise manufacturing process-specific and/or parts program-specific movements, which are to be carried out for the manufacture of the target geometry.

The web publication “Light construction of power lathe chucks” by Philipp Sehräder describes an initial model, implemented in ANSYS, for a topology optimization which contains the necessary boundary conditions such as forces and bearings.

The published, unexamined patent application DE 103 60 530 A1 describes a method for commissioning a machine, wherein at least one parameter set, which contains at least one machine parameter, is fed to a numerical machine simulator and the implementation of the machine commissioning is tested with the machine simulator.

Against this background, the object underlying the invention is to specify an improved method for dimensioning a receiving device.

The object is achieved according to the invention by a method for dimensioning a receiving device, which is configured for use in an industrial process, having the following steps: simulating control of the industrial process by means of a virtual controller, outputting dynamic control variables on the basis of the simulation of the virtual controller, determining dynamic process variables on the basis of the dynamic control variables and dimensioning the receiving device by taking into account the determined dynamic process variables.

The object is further achieved according to the invention by a method for manufacturing a receiving device, which is dimensioned according to a method of this type.

Moreover, the object is achieved according to the invention by a control unit comprising at least one processor, which is set up to perform the following steps: simulating control of the industrial process by means of a virtual controller, outputting dynamic control variables on the basis of the simulation of the virtual controller, determining dynamic process variables on the basis of the dynamic control variables and dimensioning the receiving device by taking into account the determined dynamic process variables.

Furthermore, the object is achieved according to the invention by a computer program comprising program code, which can be executed by at least one processor and which causes the at least one processor to perform a method of this type.

The advantages and preferred embodiments disclosed below in relation to the method can be transferred accordingly to the control unit and the computer program.

The consideration underlying the invention is that of improving a dimensioning of a receiving device, which is configured to receive a workpiece in an industrial process, for instance, by including dynamic process variables, such as forces and torques to be received by the receiving device. A dimensioning of this type can comprise inter alia a positioning and fixing of active surfaces, e.g. clamping points on a workpiece and/or a clamping plate. For instance, the receiving device is realized as a clamping device and inserted into a machine tool. The industrial process can comprise inter alia milling, in particular CNC milling, turning and/or an additive method.

By simulating control of the industrial process by means of a virtual controller, machining paths, machining sequences and routes are analyzed. A virtual controller of this type is for instance the virtual Sinumerik, abbreviated to VNCK, which enables a dynamic simulation of the machining process. In particular, the relevant positions of the components controlled by the controller are calculated over time in the industrial process. In addition or alternatively, manipulated variables can be calculated for dynamic components, axles and/or at least one spindle, in particular a tool spindle. Dynamic control variables are output on the basis of results of the simulation of the virtual controller. By way of example, a dynamic configuration, settings of regulator parameters, settings of axles and compensation variables of the controller are output. In a further step, dynamic process variables are determined on the basis of the dynamic control variables. The dynamic process variables can also comprise future movement steps in addition to process forces and torques acting on the workpiece. In particular, the forces and torques to be received by the receiving device are calculated for all relevant positions over time. In a following step, the receiving device is dimensioned by taking into account the determined dynamic process variables. During the dimensioning, a further simulation, which combines a, in particular three-dimensional, model of the components relevant to the industrial process, which comprises at least the receiving device, with the determined dynamic process variables, so that the receiving device can be realized optimally in respect of the process forces occurring in the industrial process. An optimal realization is understood to mean inter alia an adequate, in particular mechanical, resilience combined with an easy execution for good handling and machine dynamics and favorable manufacturing costs. For instance, a machine tool is simulated by means of a 3D model, which maps the kinematics of the machine tool. The processor of the control unit can inter alia be realized as a microprocessor, microcontroller or as an ASIC (application-specific integrated circuit). The computer program can comprise a digital twin or be embodied as one such. A digital twin of this type is shown in the published, unexamined patent application US 2017/0286572 A1, for instance. The disclosure of US 2017/0286572 A1 is included in the present application by means of reference. The “digital twin” is a digital representation of the components relevant to the industrial process, for instance.

A further embodiment provides that an FEM simulation of the industrial process, which is fed with the determined dynamic process variables, is carried out for dimensioning the receiving device. In particular, the FEM simulation comprises a three-dimensional model of the components relevant to the industrial process, said model comprising at least the receiving device. The determined dynamic process variables are combined with the FEM simulation so that the receiving device can be realized optimally in respect of process forces occurring during the industrial process. For instance, a machine tool with receiving device, which is implemented as a 3D model, which maps the kinematics of the machine tool, is simulated by means of a FEM resolver. By combining the results from the simulation of the virtual controller, in particular the virtual Sinumerik, with an FEM simulation, high precision is achieved so that a high reliability with respect to optimization can be achieved. A clamping device can therefore be set up and optimized very exactly for occurring static and dynamic loads.

A further embodiment provides that the dynamic process variables comprise forces and torques which act on a workpiece from the receiving device, wherein the forces and torques are taken into account in an FEM simulation of the industrial process. By using a virtual controller, the dynamic configurations of the real machine can essentially be mapped 1:1, for instance. The forces and torques are determined in particular by means of the results from the simulation of the virtual controller. The receiving device can therefore be set up and optimized precisely and reliably for occurring static and dynamic loads.

A further embodiment provides that a clamping device is dimensioned, wherein requisite clamping forces are determined by means of the FEM simulation, wherein the clamping device is dimensioned by taking into account the requisite clamping forces. A clamping device of this type can be executed as a mechanical, hydraulic, magnetic or vacuum-specific clamping device. Requirements placed on a clamping device are inter alia secure clamping of the workpiece and minimal deformation of the same during clamping. The clamping device can be dimensioned optimally in particular in respect of these requirements by means of an FEM simulation by taking into account the requisite clamping forces.

A further embodiment provides that critical machining steps of the industrial process are simulated when the receiving device is dimensioned. Critical machining steps of this type are inter alia steps with load peaks, torque peaks, narrow radii, movement reversal, penetration into the workpiece, in particular an initial contact with and a departure from the workpiece. In particular, only the critical machining steps of the industrial process are simulated, which results in a low computing time while, at the same time, having high reliability of the simulation.

A further embodiment provides that the industrial process comprises a cutting method, wherein a cutting simulation is additionally carried out in order to dimension the receiving device. By way of example, within the scope of the cutting simulation, a cutting force calculation is carried out in order to determine anticipated forces which result in improved accuracy.

A further embodiment provides that static and dynamic loads of the receiving device are simulated during the dimensioning. This leads to improved accuracy of the simulation.

A further embodiment provides that static and dynamic loads are used to optimize a geometry of the receiving device. An optimization can take place manually, by means of at least one parameter sweep of a parameter of the geometry and/or by means of artificial intelligence, for instance by means of a, in particular trained, neural network. Optimization of this type enables an optimization of local dimensions in relation to the influential static and dynamic forces, in other words material is provided where it is used.

One exemplary embodiment of the invention is explained below in greater detail with reference to a FIGURE.

The FIGURE shows a method for manufacturing a receiving device, which is configured for use in an industrial process. For instance, the receiving device is realized as a clamping device and inserted into a machine tool. The industrial process can comprise inter alia milling, in particular CNC milling, turning and/or an additive method. The method contains the simulation 2 of control of the industrial process by means of a virtual controller. A virtual controller of this type is for instance the virtual Sinumerik, abbreviated to VNCK. The simulation 2 of the machining process of the control is carried out dynamically, wherein in addition to a receiving situation 4 of the receiving device, a process definition 6 and a workpiece definition 8 can be taken into account. By using a virtual controller, the dynamic configurations of the real machine can essentially be mapped 1:1, for instance. The receiving situation 4 contains inter alia position information in the workspace and information relating to a machine kinematics, for instance the machine tool. The process definition 6 can comprise inter alia information about tools, tool paths and/or technology values. The workpiece definition 8 contains inter alia information about a geometry of the workpiece and/or information about from which material the workpiece is produced. Process sequences and routes are analyzed in the process simulation. Setpoint variables of the forces are calculated from manipulated variables, e.g. on the drives of the machine tool.

In a further step, an output 10 of dynamic control variables takes place on the basis of the simulation 2 of the virtual controller. By way of example, a dynamic configuration, settings of regulator parameters, settings of axles and compensation variables of the control are output.

In a further step, dynamic process variables are determined 12 on the basis of the dynamic control variables. The forces and torques to be received by the receiving device are inter alia calculated for all relevant positions over time, in particular taking into account the machine, the component, the tools and the clamping situation. For instance, a setpoint variable output of the process forces on the workpiece is carried out on the basis of manipulated variables on the drives of the machine. Furthermore, the dynamic process variables can comprise future movement steps, in particular of the receiving device.

In a further step, the receiving device is dimensioned 14 by taking into account the determined dynamic process variables. During dimensioning 14, static and dynamic loads of the receiving device are simulated, in order to determine requisite clamping forces, for instance, to fix a workpiece in the industrial process, wherein the receiving device is dimensioned by taking into account the requisite clamping forces. While the quality of the receiving device is negatively affected in the case of excessive stresses and/or excessive pressure, the workpiece can detach itself from a clamping position when stresses are too low.

In order to determine the requisite clamping forces, the machine tool is simulated by means of a 3D model, which maps the kinematics of the machine tool. In particular, a FEM simulation of the industrial process is carried out. Input variables for the FEM simulation are process forces, torques and/or future movement steps which act on the workpiece, for instance. A machining program for virtual machining of the workpiece contains at least critical machining steps of the industrial process. Critical machining steps of this type are inter alia steps with load peaks, torque peaks, narrow radii, movement reversal, penetration into the workpiece, in particular an initial contact with and a departure from the workpiece.

If the industrial process contains a cutting method, a material removal is inter alia simulated. In order to dimension 14 the receiving device, a cutting simulation can additionally be carried out, within the scope of which a cutting force calculation takes place in order to determine anticipated forces. The determined data . . . can optionally be converted into input parameters, for instance in the clamping situation, of a further iteration of the process simulation and used to obtain an improved result by means of the further iteration of the process simulation. Following successful dimensioning 14 of the receiving device, manufacture 16 of the same takes place, wherein data relating to the dimensioning 14 the receiving device is transmitted to a machine tool and wherein the receiving device is produced by means of the machine tool. The entire workflow can be integrated into a CAD/CAM chain.

In summary, the invention relates to a method for dimensioning a receiving device which is configured for use in an industrial process. In order to specify an improved method for dimensioning the receiving device, the following steps are proposed: simulating 2 of control of the industrial process by means of a virtual controller, outputting 10 of dynamic control variables on the basis of the simulation of the virtual controller, determining 12 of dynamic process variables on the basis of the dynamic control variables and dimensioning 14 of the receiving device by taking into account the determined dynamic process variables.

1.-12. (canceled)

13. A method for dimensioning a receiving device for use in an industrial process, the method comprising:
simulating control of the industrial process by a virtual controller;
outputting a dynamic control variable based on the simulation of the virtual controller;
determining a dynamic process variable based on the dynamic control variable; and
dimensioning the receiving device by taking into account the determined dynamic process variable.

14. The method of claim 13, wherein the receiving device is dimensioned by carrying out a FEM simulation, which is fed with the determined dynamic process variable.

15. The method of claim 13, wherein the dynamic process variable comprises a force and/or a torque acting on a workpiece from the receiving device and taken into account in an FEM simulation of the industrial process.

16. The method of claim 13, wherein the receiving device is embodied as a clamping device, the method further comprising determining a requisite clamping force by FEM simulation, with the clamping device being dimensioned by taking into account the requisite clamping force.

17. The method of claim 13, wherein a critical machining step of the industrial process is simulated during the dimensioning of the receiving device.

18. The method of claim 13, wherein the industrial process comprises a cutting method, the method further comprising carrying out a cutting simulation in addition to the dimensioning of the receiving device.

19. The method of claim 13, further comprising simulating static and dynamic loads of the receiving device during the dimensioning of the receiving device.

20. The method of claim 19, further comprising optimizing a geometry of the receiving device based on the static and dynamic loads.

21. A method for manufacturing a receiving device for use in an industrial process, the method comprising:
dimensioning the receiving device by a method as set forth in claim 13;
transmitting data relating to the dimensioning of the receiving device to a machine tool; and
manufacturing the receiving device by the machine tool.

22. A control unit, comprising a processor designed to execute the steps of:
simulating control of an industrial process by a virtual controller;
outputting a dynamic control variable based on the simulation of the virtual controller;
determining a dynamic process variable based on the dynamic control variable; and
dimensioning a receiving device by taking into account the determined dynamic process variable.

23. The control unit of claim 22, wherein the processor is designed to dimension the receiving device by carrying out a FEM simulation, which is fed with the determined dynamic process variable.

24. The control unit of claim 22, wherein the dynamic process variable comprises a force and/or a torque acting on a workpiece from the receiving device, said processor being designed to take into account the dynamic process variable when carrying out a FEM simulation of the industrial process.

25. The control unit of claim 22, wherein the receiving device is embodied as a clamping device, the processor being designed to determine a requisite clamping force by FEM simulation and to take into account the requisite clamping force when dimensioning the clamping device.

26. The control unit of claim 22, wherein the processor is designed to simulate a critical machining step of the industrial process during the dimensioning of the receiving device.

27. The control unit of claim 22, wherein the industrial process comprises a cutting method, said processor being designed to carry out a cutting simulation in addition to the dimensioning of the receiving device.

28. The control unit of claim 22, wherein the processor is designed to simulate static and dynamic loads of the receiving device during the dimensioning of the receiving device.

29. The control unit of claim 28, wherein the processor is designed to optimize a geometry of the receiving device based on the static and dynamic loads.

30. The control unit of claim 22, wherein the processor is designed to transmit data relating to the dimensioning of the receiving device to a machine tool for manufacturing the receiving device by the machine tool.

31. A computer program product comprising a non-transitory computer readable medium storing computer readable program code, which when loaded into a processor and executed by the processor causes the processor to perform a method as set forth in claim 13.
